(19) United States
(12) Patent Application Publication
(10) Pub. No.: US 2005/0207832 A1
(43) Pub. Date: Sep. 22, 2005

(54) Framework construction

(76) Inventor: Lukas Matt, Mauren (LI)

Correspondence Address: BACHMAN & LAPOINTE, P.C., 900 CHAPEL STREET, SUITE 1201, NEW HAVEN, CT, 06510, US

(21) Appl. No.: 10/515,724

(22) PCT Filed: May 14, 2003
(86) PCT No.: PCT/CH03/00309

§ 371 Date: Nov. 23, 2004

(30) Foreign Application Priority Data
May 27, 2002 (CH) 880/02

(51) Int. Cl. F16D 1/00

(52) U.S. Cl. 403/169

(57) ABSTRACT

A framework construction, for example, a bookshelf or the like, consists of a plurality of profiled carriers with two types of profiled carriers being provided. The first profiled carrier(s) have tapped holes arranged vertically in relation to the longitudinal axis thereof and are to be transversally mounted, i.e. depth-wise, while the second profiled carrier(s) have axially arranged threaded bolts on the ends thereof, and are to be mounted length-wise and height-wise. At least one of the threaded bolts can be axially displaced and rotatably mounted. The threaded bolt comprises an engaging device on its free end, which enables it to be screw down, for example, by a simple spanner. In this way, the framework construction consists of only two parts. Additional connection or fixing elements are not required. The framework construction is very suitable for self-assembly.

The present invention relates to a framework construction comprising connectable and detachable profiled beams.

It is known to connect profiled beams to a framework construction in a detachable manner, in order to manufacture household articles, such as items of furniture and room dividers. There is always a connecting element, in the form of a sphere or a cube, for example, at the centre of framework constructions of this type. The connecting element is provided with a large number of holes or recesses, in order to screw in or clamp the profiled beams, which are generally configured as round tube. For this purpose, there are bolts or threaded bolts at the two ends of the profiled beams. Pins that act as expanding elements are also known. Owing to the modular structure of said framework constructions, the height, length and shape of the respective household article may be adapted in various ways and also subsequently altered. Shelves, wall and ceiling elements, and also doors and the like may be fitted or wedged into the frames formed by the framework construction.

Since the known framework constructions, apart from profiled beams, also always comprise connecting elements, they are relatively complex and expensive. In the case of extended configurations comprising expanding pins, assembly may only be undertaken by skilled personnel. During dismantling, which is usually inevitable when moving house, the expanding pins are often damaged and have to be replaced. It is known from EP 0 158 149 to connect the profiled beams to the spherical connecting element acting as the centre point using a threaded bolt. The threaded bolt protrudes axially from the front end of the profiled beams and is to be screwed into a tapped hole in a connecting element. A sleeve is provided for rotating the threaded bolt. Said sleeve is attached rotatably, but axially non-displaceably, to the front end of the profiled beam. The threaded bolt is screwed into the spherical connecting element via an outer entrainment surface, which is configured with two sides or as a hexagon, by rotating the sleeve, and the profiled beam is thus secured to the connecting element. The drawbacks of said construction are the high manufacturing costs of the inner entrainment surfaces of the sleeve for the threaded bolt and the high degree of complexity in the production. It must be ensured that the axial play of the sleeve to the profiled beam is as low as possible, wherein it must still be possible to rotate the sleeve without exerting a high degree of force. However, axial play between the sleeve and the profiled beam is in practice inevitable. Moreover, as previously stated, a sphere that acts as a connecting element and is complex to produce is necessary. Since the sleeve, which is rotatable from outside, is provided with two edges or a hexagon, the sleeve, as a link from the round rod to the sphere, is also not very attractive and makes the item of furniture much less pleasing to look at.

A framework construction in which a threaded bolt is axially displaceable in the profiled beam, where it is secured against falling out in a blind hole, by means of its head, is also known. The blind hole is formed by an annular end plate that is welded in the tube of the profiled beam. A complex, spherical connecting element, which acts as the centre point, is also provided in said framework construction, which increases the cost of the construction. A profiled beam may be assembled on the spherical connecting element by screwing the threaded bolt using a screwdriver that is to be fed through the connecting element. The threaded bolt may in this case cooperate with a spring, counter to the force of which it may be pressed into the end of the profiled beam. However, the assembly of the additional profiled beams is not always possible in this manner. Furthermore, said framework construction has in practice proven not to be very stable. The double transition, from the first profiled beam to the sphere surface of the connecting element and therefrom to the following profiled beam, has an adverse effect.

On the basis of said discoveries, the object of the invention is to provide a framework construction comprising connectable and detachable profiled beams that may be produced easily and cost-effectively, may be assembled and dismantled by a layman and is visually appealing.

The framework construction according to the invention corresponds to the characterising features of claim 1. Further advantageous developments of the inventive idea emerge from the dependent claims.

Preferred embodiments of the invention will be described below in greater detail with reference to the drawings, in which:

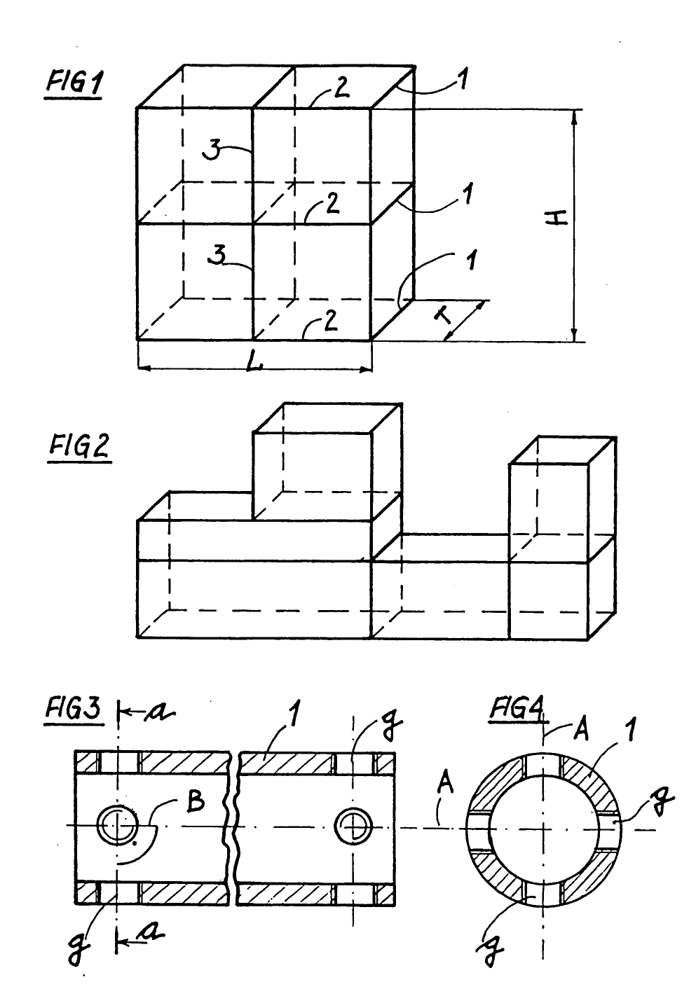

FIGS. 1+2 show examples of cubic framework constructions;

FIGS. 3+4 show construction details of a first profiled beam;

FIGS. 5-8 show alternative examples of the first profiled beam;

FIG. 9 shows construction details of a second profiled beam;

FIG. 10 shows a section from a framework construction comprising three profiled beams screwed to one another.

The proposed framework construction comprises profiled beams, preferably in the form of a steel tube that is round in cross-section. The framework construction is substantially constructed on two different types of profiled beams. The first type, as is apparent from FIG. 1, form the profiled beams 1 to be incorporated transversely. The length of said profiled beams 1 defines the depth T of the framework construction—for example, a bookshelf, a sideboard, a case or the like. The second type of profiled beams form the profiled beams 2 to be incorporated longitudinally and the profiled beams 3 to be incorporated vertically. The length and number of the profiled beams 2 to be incorporated longitudinally determine the length L, and the length and number of the profiled beams 3 to be incorporated vertically determine the height H, of the framework construction.

As illustrated in FIG. 2, the structure of the framework construction does not have to be complete. Recesses, attachments and appendages may also be provided, in flexible form. This is known as modular framework construction. In order to simplify the drawings, all of the embodiments are illustrated in cube form, i.e. the profiled rods are at right angles to one another. However, the invention is not limited to said geometric form. As is also apparent from FIG. 2, it is also possible to use profiled beams of different lengths in a framework construction.

FIG. 3 to 8 show various examples of a profiled beam 1 to be incorporated transversely, i.e. in the depth T, in a cubic framework construction. Tapped holes g, which are preferably in a plane, are located at both ends of said profiled beam 1. The axes of symmetry A of the tapped holes g extend perpendicularly to the longitudinal axis B of the profiled beam 1. Said tapped holes g may also be formed in a different axial position of the profiled beam 1 and in a different quantity, as required. The tapped holes g at one end of a profiled beam 1 extend through the longitudinal axis B of the profiled beam 1 at the same angle as the holes at the opposite end of the profiled beam 1.

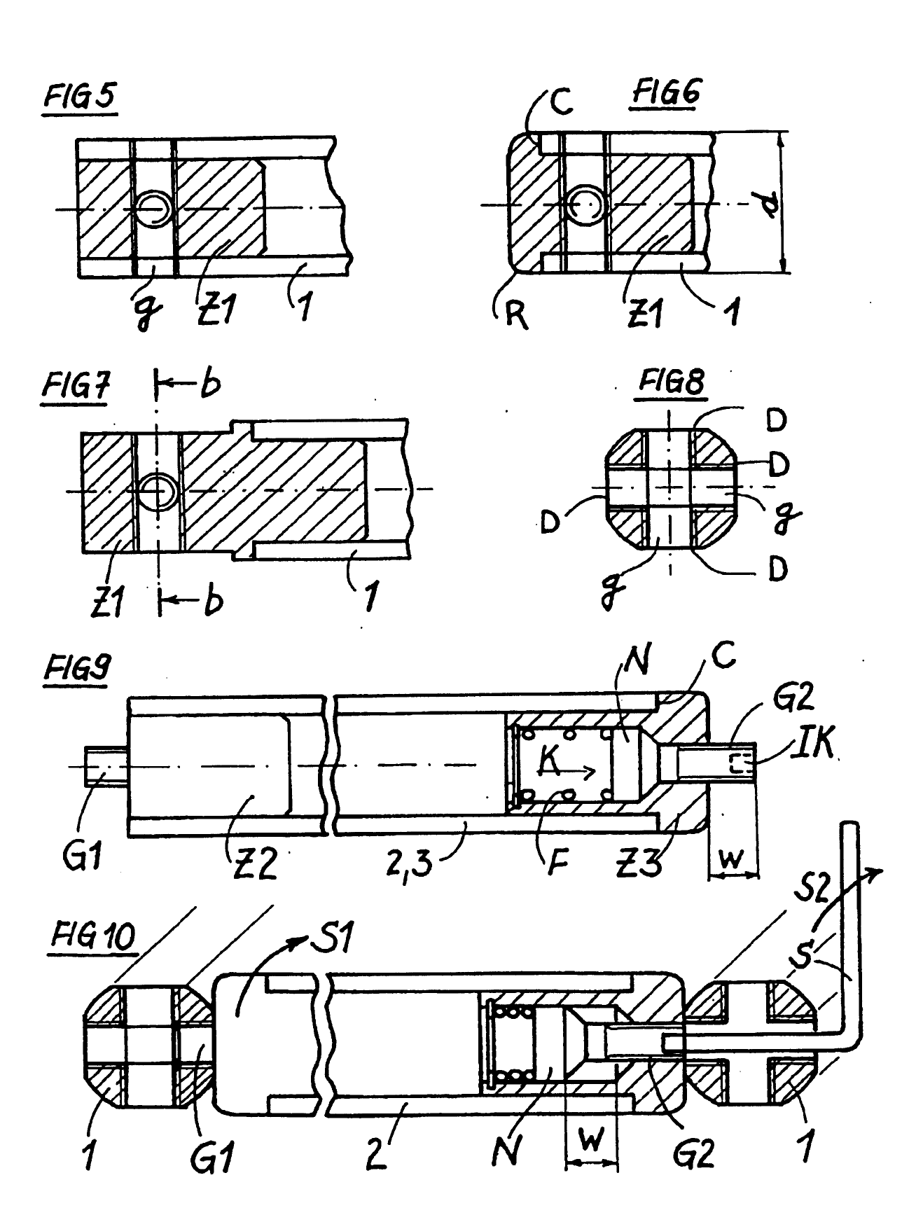

FIG. 4 shows a section of the tapped holes g along the line a-a in FIG. 3. In order to attain a sufficiently supportive thread depth, in the case of thin-walled tubes, it is however advantageous, as illustrated in FIG. 5, to press an attachment, in the form of a pin Z1, flush into the profiled carrier 1. At the same time, said pin Z1 forms a seal. FIG. 6 shows a visually more attractive seal, with a pin Z1 having a bottom radius R or a chamfer and a flange C that exhibits the same diameter as the external diameter d of the cross-section of the profiled beam 1. A further expedient embodiment of the profiled carrier 1, comprising four tapped holes g, is shown in FIGS. 7 and 8. In this case, the tapped holes g are located in a pin Z1, which is rigidly connected to the profiled beam 1 by means of a press fit. Said pin Z1 also comprises four flat portions D, which are each formed perpendicularly to the tapped holes g. Said flat portions serve the profiled beams 2 and 3 to be incorporated longitudinally and vertically, which profiled beams are screwed into the tapped holes g of the profiled beams 1 using threaded bolts G1 and G2, in order to provide secure and stable support. The two pins Z1 of the one end and the other end of the first profiled beam 1 are pressed into the profiled beam 1 such that the respective tapped holes g are at the same angle to one another, so that additional screwed-in profiled beams 2 and 3 extend parallel to each other at said two ends.

FIG. 9 shows the structural features of the profiled beams 2 and 3 to be incorporated longitudinally and vertically. At one end of the profiled beam 2 and 3, a pin Z2 is pressed in. Said pin Z2 comprises a threaded bolt G1, which is preferably configured in a single piece with the pin Z2 or is rigidly connected to the pin Z2. The threaded bolt G1 is therefore rigidly connected to the profiled beam 2 or 3 to be incorporated longitudinally or vertically. At the opposite end, a pin Z3 is pressed tightly into the profiled beam 2 and 3. In said pin Z3, a screw N is axially displaceable counter to a spring F. In the illustrated configuration, the screw N may be pressed into the profiled beam 2 or 3, counter to the force K of the spring F, by the distance w. The spring F is supported on the pressed-in pin Z3. On its shaft side, the screw N comprises an inner hexagon IK. It is freely rotatable in the pin Z3, in both directions of rotation, using said inner hexagon IK. The two pins Z2 and Z3, which are rigidly connected to the profiled beams 2 and 3, may also be configured without a flange C. In this case, it is then pressed in flush with the outer surface of the profiled beam 2 or 3, as is apparent from the left-hand side of FIG. 9.

FIG. 10 shows a section cut out of a framework construction comprising two profiled beams 1 to be incorporated transversely and one profiled beam 2 to be incorporated longitudinally. It is apparent here how the profiled beams 2 to be incorporated longitudinally and, similarly, the profiled beams 3 to be incorporated vertically are screwed to the profiled beams 1 to be incorporated transversely, using the protruding threaded bolts G1 and G2. In a first assembly step S1, the threaded bolt G1, which is rigidly connected to the profiled beam 2 and 3 to be incorporated longitudinally or vertically, is screwed into the tapped hole g of the profiled beam 1 to be incorporated transversely, by rotating the corresponding profiled beam 2 or 3. Said screwing-in may be done manually or using what is known as a strap wrench. Said assembly is repeated until it is no longer possible to screw-in using the fixedly arranged threaded bolt G1. The assembly is then continued in a second assembly step S2, in that the profiled beam 2 or 3 to be further assembled is placed against the first profiled beam 1, by pressing back the moving threaded bolt G2 by the distance w, and is screwed using a hexagonal wrench S, which is to be fed through the tapped holes g of the profiled beam 1. This sequence of assembly step S1 and assembly step S2 is applied until the desired framework construction has been produced. Dismantling takes place in the reverse order.

Both simple cubic and also geometrically complex framework constructions may be constructed in this way and dismantled again using the reverse operating procedure. No loose fastening elements, which might get lost or be delivered incomplete, are required for this purpose. A hexagonal wrench is the only implement necessary. The framework construction according to the invention manages entirely without centre or corner elements, such as spheres or cubes, for example.

1-17. (canceled)

18. A framework construction comprising a plurality of connectable and detachable profiled members, said members comprising at least one first profiled beam having a first longitudinal axis and at least one screw-threaded hole that is arranged perpendicularly to the first longitudinal axis of the beam in a region of at least one end of said beam and at least one additional profiled beam having a second longitudinal axis and a screw-threaded bolt arranged at one end of said additional beam coaxially or axially to the second longitudinal axis, the screw-threaded hole in said at least one first profiled beam being adapted to receive the screw-threaded bolt on said at least one additional profiled beam.

19. A framework construction as claimed in claim 18, further comprising at least two types of profiled beams including said at least one first profiled beam which comprises, at least in the region of said one end, said at least one screw-threaded hole being arranged perpendicularly to the first longitudinal axis of said at least one first profiled beam and said at least one additional profiled beam having the second longitudinal axis and a respective screw-threaded bolt arranged at each end, said bolts extending coaxially or axially to the second longitudinal axis of said at least one additional profiled beam.

20. A framework construction as claimed in claim 18, in which at least one attachment is arranged at one end of said at least one first profiled beam, and is connected thereto, and in which at least one screw-threaded hole is formed.

21. A framework construction as claimed in claim 20, in which the at least one first profiled beam is configured as a hollow profiled member and said at least one attachment in the form of a pin is arranged in said hollow profiled member.

22. A framework construction as claimed in claim 21, in which the pin is impressed in the hollow profiled member.

23. A framework construction as claimed in claim 21, in which the pin is arranged in the hollow profiled member so completely that the pin ends flush therewith.

24. A framework construction as claimed in claim 21, in which a part of the pin arranged in the hollow profiled member protrudes from an end of the hollow profiled member and is provided with a chamfer and a flange which has a diameter identical to an external diameter of the at least one first profiled beam.

25. A framework construction as claimed in claim 21, in which the screw-threaded hole is introduced both through the hollow profiled member and in the pin arranged therein.

26. A framework construction as claimed in claim 24, in which a screw-threaded hole is formed in a part of the pin that protrudes from the end of the hollow profiled member.

27. A framework construction as claimed in claim 18, in which at least one of said additional profiled beams has a screw-threaded bolt which is axially displaceable and rotatable in the second longitudinal axis of the additional profiled beam or parallel to the second longitudinal axis at at least one end of said additional profiled beam.

28. A framework construction as claimed in claim 27, in which the additional profiled beam has a screw-threaded bolt which is connected fixedly and non-rotatably to the profiled beam at the end opposite the end comprising the axially displaceable and rotatable screw-threaded bolt.

29. A framework construction as claimed in claim 27, in which a spring is provided and in which the axially displaceable screw-threaded bolt is adapted to be pressed into the additional profiled beam counter to the force of said spring and the screw-threaded bolt comprises an engaging device, at its free end, in order to be able to rotate the screw-threaded bolt using an implement.

30. A framework construction as claimed in claim 29, in which the at least one first profiled beam is provided with a through bore to enable an implement to be passed through the at least one first profiled beam to engage the engaging device in said axially displaceable screw-threaded bolt.

31. A framework construction as claimed in claim 18, in which said at least one first profiled beam comprises a plurality of screw-threaded holes at each end, each of the screw-threaded holes at each end of a said at least one first profiled beam being at an angle identical to one another, in order to allow two additional profiled beams, each screwed at one end, to be located parallel to each other.

32. A framework construction as claimed in claim 31, in which said at least one first profiled beam comprises flat portions, each said flat portion located perpendicularly to the screw-threaded holes in order to provide the respective additional profiled beam, which is screwed on, with a secure and stable support.

33. A framework construction as claimed in claim 18, in which the profiled beams comprise steel tubes that are circular in cross-section.

34. A framework construction as claimed in claim 18, in which the first profiled beams are incorporated transversely in a construction and the additional profiled beams are incorporated in a length and height of the construction.
